(19) United States
(12) Patent Application Publication
(10) Pub. No.: US 2018/0375147 A1
(43) Pub. Date: Dec. 27, 2018

(54) ELECTRICAL ENERGY STORAGE DEVICE WITH NON-CORROSIVE ELECTROLYTE

(71) Applicant: Alexandre Iarochenko, Toronto (CA)

(72) Inventor: Alexandre Iarochenko, Toronto (CA)

(21) Appl. No.: 15/981,960

(22) Filed: May 17, 2018

Related U.S. Application Data
(60) Provisional application No. 62/508,287, filed on May 18, 2017.

(51) Int. Cl. H01M 10/0561; H01M 10/0565; H01M 10/0566; H01M 10/058; H01M 4/66; H01M 10/054; H01M 4/62; C01B 32/158; H01M 4/86

(52) U.S. Cl. CPC H01M 10/0561; H01M 10/0565; H01M 10/0566; H01M 10/058; B82Y 30/00; H01M 10/054; H01M 4/621; C01B 32/158; H01M 4/8657; H01M 4/661

(57) ABSTRACT

The electrical energy storage device 20 comprises a plurality of electrochemical cells 28 connected in parallel and stacked on one another. Each electrochemical cell 28 includes a cathode 38 of graphite, an anode 34 of aluminum, and an electrolyte 36 disposed between them. The anode 34 and the cathode 38 each define a plurality of holes 56 that extend through the anode 34 and the cathode 38 and are spaced in a grid pattern. Each cathode 38 includes active mass 40 inside each hole 56. The electrolyte 36 is a lyophobic gel including carboxymethylcellulose, water, magnesium chloride, glycerol, nanocarbon powder including carbon nanotubes, hydroxyethyl cellulose, and sodium benzoate.

### CROSS-REFERENCE TO RELATED APPLICATION

This application claims the benefit of U.S. Provisional Application No. 62/508,287, filed on May 18, 2017.

### BACKGROUND OF THE INVENTION

### 1. Field of the Invention

This invention relates to a thin film rechargeable electrical energy storage device.

### 2. Description of the Prior Art

Existing energy storage devices with electrolytes containing magnesium suffer from corrosion of the electrodes by the electrolyte as described in “Magnesium batteries: Current state of the art, issues and future perspectives,” Mohtadi, R.; Mizuno, F. Beilstein J. Nanotechnol. 2014, 5, 1291-1311. doi:10.3762/bjnano.5.143.

The anodes of aluminum have been limited by the formation of an oxidized layer formed by a reaction between the aluminum and water or air. The oxidized layer acts as a passivation layer which restricts ion flow to the aluminum of the anode and adds resistance to the energy storage device.

### SUMMARY OF THE INVENTION

The invention is an electrical energy storage device comprising an electrode having a surface containing aluminum in contact with a lyophobic electrolyte containing water, and ions, of at least one of magnesium and chlorine.

### Advantages of the Invention

It is believed that while the battery is idle (not being charged or discharged), the aluminum is surrounded by an oxidized layer which prevents corrosion of the aluminum. When the battery is being charged or discharged, the oxidized layer is removed by a chemical reaction with the ions. The electrolyte is lyophobic to limit the amount of water in the electrolyte. Too much water in the electrolyte would prevent the removal of the oxidized layer.

### BRIEF DESCRIPTION OF THE DRAWINGS

Other advantages of the present invention will be readily appreciated, as the same becomes better understood by reference to the following detailed description when considered in connection with the accompanying drawings showing a preferred embodiment:

FIG. 1 is an exploded view of the electrical energy storage device;

FIG. 2 is an exploded view of the electrochemical cell;

Figure is a side view of an electrochemical cell;

FIG. 4 is graph showing corrosion characteristics of the electrical energy storage device;

### DESCRIPTION OF THE ENABLING EMBODIMENT

A. Electrical Energy Storage Device Physical Structure

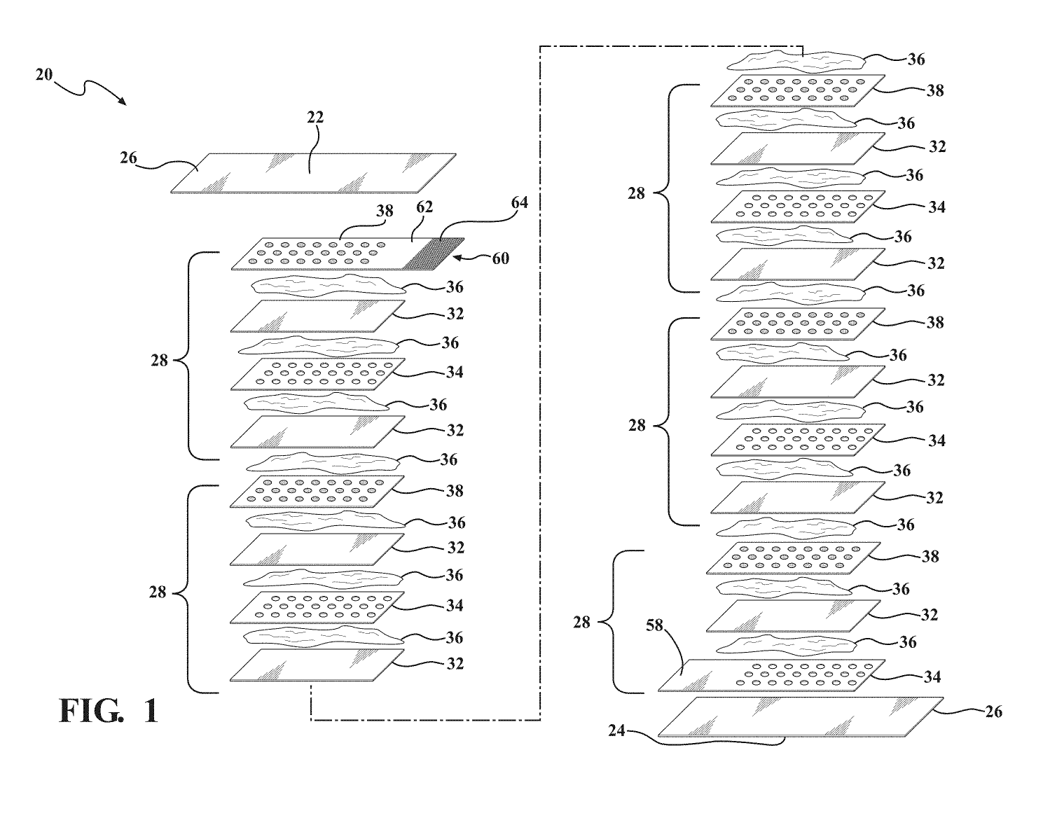

With reference to FIG. 1, the electrical energy storage device 20, generally shown, comprises a plurality of electrochemical cells 28, generally shown, having a thickness of equal to or less than 1 mm. The electrochemical cells 28 are connected in parallel and stacked on one another. The electrical energy storage device 20 includes a casing 26 having a first end 22 and a second end 24. The casing 26 is made of a non-conductive material.

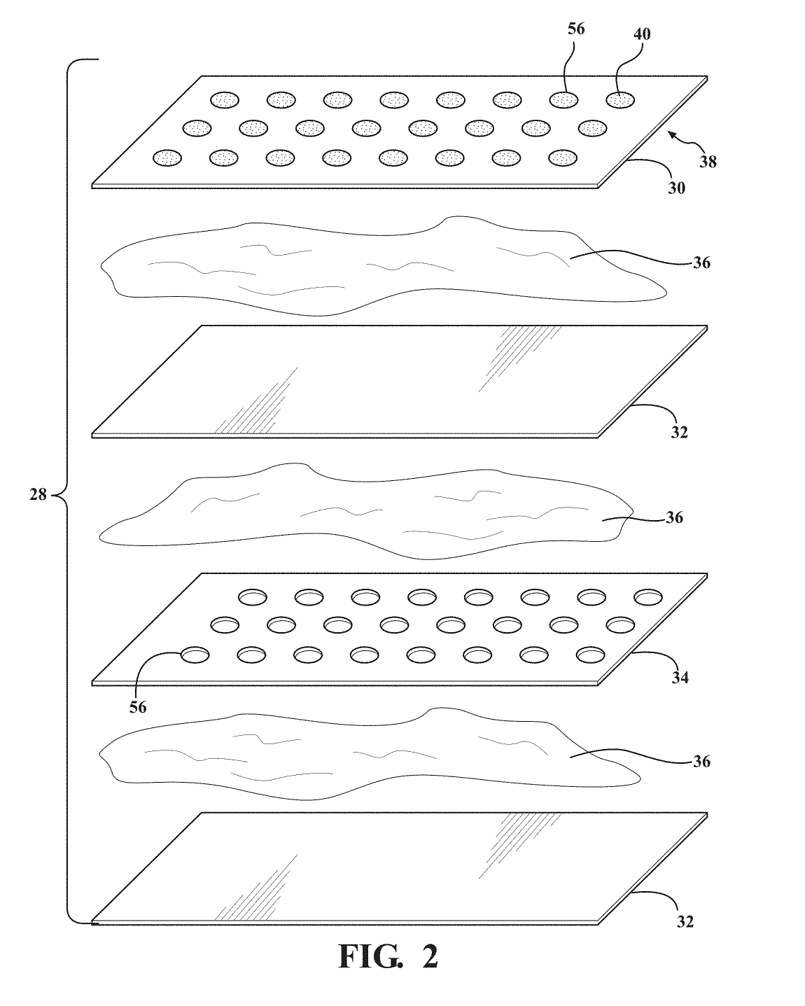

As best shown in FIG. 2, each electrochemical cell 28, generally shown, comprises at least three layers stacked on top of one another. The layers comprise of a current collector 30 disposed above a separator 32 disposed above an anode 34. An electrolyte 36 is disposed above and below the separator 32. The current collector 30 has a thickness of less than or equal to 200 μm and the anode 34 has a thickness of less than or equal to 100 μm. The anode 34 and the current collector 30 define a plurality of holes 56 that extend through the anode 34 and the current collector 30 and are spaced in a grid pattern. The holes 56 may be of any shape but circular is preferred with a diameter of 3 mm-8 mm.

Each electrochemical cell 28 also has active mass 40 inside of each hole 56 of the current collector 30. Intercalated within the active mass 40 is an intercalant. The active mass 40, the intercalant, and the current collector 30 form a cathode 38. The holes in the anode 34 allow diffusion of the intercalant through it.

The current collector 30 provides physical support for the active mass 40 and a conducting path that connects the active mass 40 in each of the holes 56 across the current collector 30. The active mass 40 in each hole of the current collector 30 acts as a miniature cell. The active mass 40 is connected in parallel across the current collector 30.

During discharge, a chemical reaction occurs at the anode causing the intercalant to move from the anode, through the electrolyte and the separator 32, and intercalate the active mass 40. A simultaneous chemical reaction proceeds at the active mass 40 that intercalates the intercalant from the electrolyte. During charging, the reverse happens; the intercalant is de-intercalated from the active mass 40 and moves through the electrolyte and the separator to the anode 34 where a chemical reaction occurs.

With reference to FIG. 1, the current collector 30 adjacent the first end 22 extends out of the casing 26 to form a protrusion 62. A positive terminal 60 comprises the protrusion 62 and copper 64 which overlays at least a portion of the said protrusion 62.The copper may be a mesh which is bent around the protrusion 62. The copper 64 may be disposed about the protrusion by chemical vapor deposition. It should be appreciated that gold, silver, or any other suitable metal may substitute for the copper 64.

The anode 34 adjacent the second end 24 extends out of the casing 26 to form a negative terminal 58.

B. Electrolyte Chemical Structure

The composition of the electrolyte and the approximate weight percent of each component are shown in Table 1. The electrolyte comprises a carboxymethylcellulose solution, glycerol, nanocarbon powder including carbon nanotubes, hydroxyethyl cellulose, sodium benzoate, and magnesium chloride.

TABLE 1
Electrolyte Composition

| Component | Weight Percent |
|---|---|
| Carboxymethylcellulose Solution | 20-40 |
| Glycerol | 20-30 |
| Nanocarbon Powder | 5-10 |
| Hydroxyethyl Cellulose | 0.1-2 |
| Sodium Benzoate | 0.1 |
| Magnesium Chloride | To Saturation |

The carboxymethylcellulose solution can include up to 10% by wt. of distilled water, however the preferred proportion of distilled water is 3-5% by wt. The hydroxyethyl cellulose acts as an emulsifier and coupling agent. The preferred percentage of hydroxyethyl cellulose is 0.1%-0.5% by wt., however the electrolyte may include up to 2 wt. %. The sodium benzoate acts as an antiseptic. The electrolyte also comprises magnesium chloride at the saturated concentration. The electrolyte is a gel of moderate viscosity.

While the battery is idle (not being charged or discharged), the aluminum of the anode 34 is surrounded by an oxidized layer. The oxidized layer comprises aluminum oxide, Al₂O₃, formed by a reaction between the aluminum of the anode and water or air. The oxidized layer acts as a passivation layer which restricts ion flow to the aluminum of the anode 34 and adds resistance to the electrochemical cell 28.

When the battery is being charged or discharged, the oxidized layer is removed by a chemical reaction with magnesium chloride and species formed thereof in the electrolyte. The carboxymethylcellulose causes the electrolyte to by lyophobic thereby preventing more than 10% wt. of water in the electrolyte. Too much water in the electrolyte would prevent the removal of the oxidized layer.

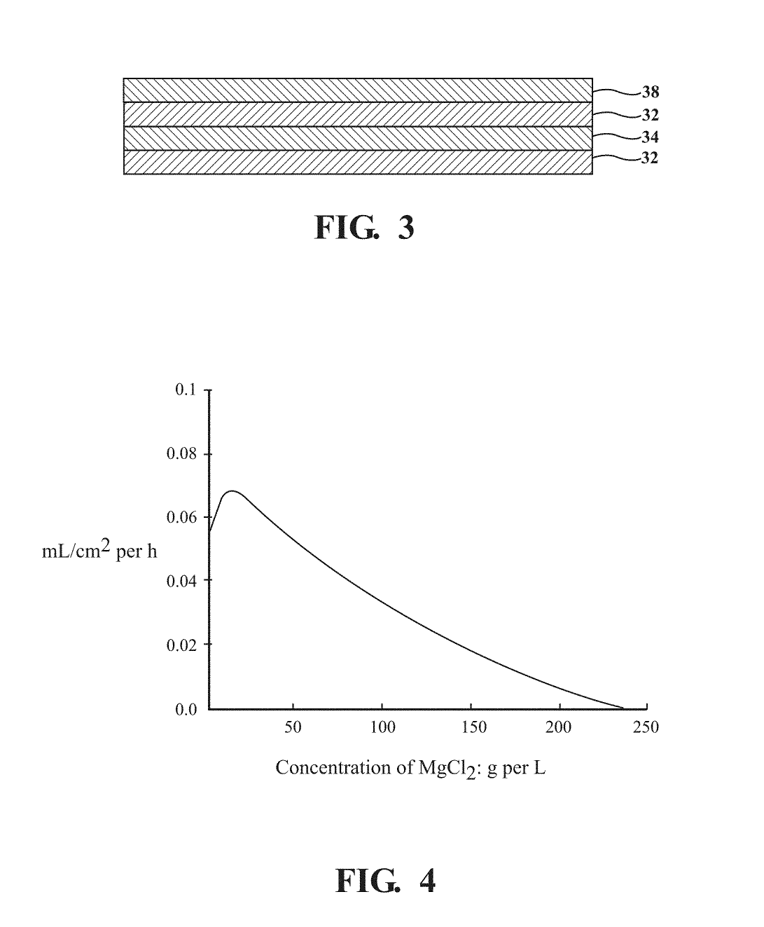

FIG. 4 shows experimental data used to determine the amount of corrosion of aluminum by the electrolyte 36 during charging and discharging. The rate of corrosion of aluminum is directly related to the amount of hydrogen gas produced in the experiment. The data for the amount of hydrogen gas produced from 1 cm² of aluminum over an hour has been plotted to show an inverse correlation between the amount of hydrogen gas produced and the concentration of magnesium chloride in the electrolyte. The y-axis represents the rate of corrosion and the x-axis represents the concentration of magnesium chloride in the electrolyte 36. At concentrations of magnesium chloride above 250 g/l the amount of hydrogen gas produced is negligible indicating that there is no corrosion. Therefore, the electrolyte 36 has been experimentally shown to be non-corrosive to the aluminum anode 34.

C. Active Mass Chemical Structure

The composition of the active mass 40 and the approximate equivalent weights of each component are shown in Table 2. The active mass 40 includes high dispersions amorphous thermally expandable graphite powder (TEGP), amorphous activated carbon powder, activated manganese dioxide powder, and a binder. In the preferred embodiment, the binder includes graphite conductive adhesive in colloidal form based on high dispersion amorphous graphite such as the graphite conductive adhesive from the Electron Microscopy Sciences catalog #12693-30. In alternative embodiments, the binder may be alkyl glue, acrylic glue, or conductive paint that includes graphite.

TABLE 2
Active Mass Composition

| Component | Parts By Weight |
|---|---|
| Amorphous Thermally Expandable | 10-20 |
| Graphite Powder (TEGP) | |
| Amorphous Activated Carbon | 2-5 |
| Activated Manganese Dioxide (MnO₂) | 2-5 |
| Graphite Conductive Adhesive (binder) | 60-86 |

The active mass 40 includes a conjugated system due to the graphite from the TEGP and the graphite conductive adhesive. The graphite in the active mass contains benzene-like carbon rings with delocalized pi electrons. The active mass 40 defines a plurality of pores. The pores provide a large surface area available for chemical reactions. The active mass prior to application must have a low viscosity to aid application of the active mass 40 to the separator 32 and current collector 30.

D. Intercalant Chemical Structure

The intercalation fluid is solution of aluminum chloride (AlCl₃) in ethanol (C₂H₅OH) up to saturation. During construction of the battery, the intercalation fluid is deposited on the active mass 40 and allowed to intercalate the active mass 40. The active mass is then heated to remove the ethanol by evaporation. The intercalant improves the charge density of the active mass 40 up to 383 ampere-hour per kilogram.

TABLE 3
Intercalation Liquid Composition

| Component | Composition |
|---|---|
| Ethanol | |
| Aluminum Chloride (AlCl3) | To Saturation |

E. Electrodes Chemical Structures

The current collector 30 includes thermo expandable graphite foil. The anode 34 includes aluminum of 99.95% by wt purity or higher. Impurities in the aluminum reduce the open circuit voltage and the energy density.

F. Separators Chemical Structure

The separator 32 has a thickness between 5 μm and 20 μm and must be wettable by aqueous and organic liquids. In the preferred embodiment, the separator 32 comprises a blend of cellulose nanofibers and microfibers. The separator 32 is an electrical insulator and has small pore sizes and high porosity resulting in high permeability to aluminum chloride and ions made therefrom. The ions comprise an ion current as they migrate between and react with the anode 34, and the active mass 40, to charge and discharge the electrical energy storage device 20.

ELEMENT LIST

| Element Symbol | Element Name |
|---|---|
| 20 | electrical energy storage device |
| 22 | first end |
| 24 | second end |
| 26 | casing |
| 28 | electrochemical cells |
| 30 | Current collector |
| 32 | separator |
| 34 | anode |
| 36 | electrolyte |
| 38 | cathode |
| 40 | active mass |
| 56 | holes |
| 58 | negative terminal |
| 60 | positive terminal |
| 62 | protrusion |
| 64 | copper |

What is claimed is:

1. An electrical energy storage device 20 comprising;
an electrode having a surface containing aluminum,
an electrolyte in contact with said aluminum of said electrode,
said electrolyte being lyophobic and containing water and ions, and
said ions containing at least one of magnesium and chlorine.

2. The electrical energy storage device 20 of claim 1 further comprising;
first ions containing magnesium and second ions containing chlorine.

3. The electrical energy storage device 20 of claim 1 further comprising;
said ions containing magnesium and chlorine.

4. The electrical energy storage device 20 of claim 1 further comprising;
said electrolyte including carboxymethylcellulose.

5. The electrical energy storage device 20 of claim 4 further comprising;
said electrolyte being at least 18% by weight carboxymethylcellulose.

6. The electrical energy storage device 20 of claim 1 further comprising;
said electrolyte being a maximum of 5% by weight water.

7. The electrical energy storage device 20 of claim 1 further comprising;
said electrolyte being a minimum of 3% by weight water.

8. The electrical energy storage device 20 of claim 1 further comprising;
said electrolyte including carbon nanotubes.

9. The electrical energy storage device 20 of claim 1 further comprising;
said electrolyte including sodium benzoate.

10. The electrical energy storage device 20 of claim 1 further comprising;
said electrolyte including glycerol.

11. The electrical energy storage device 20 of claim 1 further comprising;
a cathode 38 including active mass 40, and
an intercalant including ions selected from the list including ions containing aluminum and ions containing chlorine and ions formed from aluminum chloride.

12. The electrical energy storage device 20 of claim 1 further comprising;
a cathode 38 including a current collector 30 of graphite.

13. The electrical energy storage device 20 of claim 1 further comprising;
an anode 34 comprising primarily of aluminum.

14. The electrical energy storage device 20 of claim 1 further comprising;
active mass 40 including manganese dioxide.

15. The electrical energy storage device 20 of claim 1 further comprising;
active mass 40 including graphite and activated carbon.

16. The electrical energy storage device 20 of claim 1 further comprising;
said electrolyte including
a carboxymethylcellulose solution at 20-40% by weight and including
less than 10% by weight distilled water,
glycerol at 20-30% by weight
carbon nanotubes 5-10% by weight
hydroxyethyl cellulose at is 0.1%-0.5% by weight
sodium benzoate as an antiseptic at 0.1% by weight,
magnesium chloride at the saturation limit of said electrolyte,

17. The electrical energy storage device 20 of claim 1 further comprising;
a current collector 30,
an anode 34,
said current collector 30 and said anode 34 defining a plurality of holes 56 extending through said current collector 30 and said anode 34.

18. The electrical energy storage device 20 of claim 17 further comprising;
all of said holes 56 in said current collector 30 having an accumulated area greater than the surface area of said current collector 30 surrounding said holes 56,
all of said holes 56 in said anode having an accumulated area greater than the surface area of said anode 34 surrounding said holes 56.

19. The electrical energy storage device 20 of claim 17 further comprising;
active mass 40 being disposed in each of said holes 56 of said current collector.

20. An electrical energy storage device 20 comprising;
at least one electrochemical cell 28 for storing electrical energy,
said electrochemical cells 28 being connected in parallel and stacked on one another with each having a maximum thickness of 1 mm,
each of said electrochemical cells 28 including a current collector 30 of thermo expandable graphite foil with a maximum thickness of 200 μm,
each of said electrochemical cells 28 including an anode 34 having a maximum thickness of 100 μm,
said current collector 30 and said anode 34 define a plurality of holes 56 extending through said current collector 30 and said anode 34 and being spaced in a grid pattern with each hole 56 and being circular of diameter of between 3 mm and 8 mm,
all of said holes 56 in said current collector 30 having an accumulated area greater than the surface area of said current collector 30 surrounding said holes 56,
all of said holes 56 in said anode having an accumulated area greater than the surface area of said anode 34 surrounding said holes 56,
active mass 40 being disposed in each of said holes 56 of said current collector 30 and having a conjugated system and defining a plurality of pores which provide surface area available for chemical reactions,
said active mass 40 including
amorphous thermally expandable graphite powder at 10-20 parts by weight,
amorphous activated carbon at 2-5 parts by weight,
activated manganese dioxide at 2-5 parts by weight,
a binder including high dispersion amorphous graphite at 60-86 parts by weight,
a cathode 38 including said active mass 40 and said current collector 30 with said active mass 40 in each of said holes 56 of said current collector 30 being electrically connected in parallel,
each of said electrochemical cells 28 including an intercalant including aluminum chloride and ions thereof intercalated in said active mass 40,
each of said electrochemical cells 28 including at least one separator disposed between said current collector 30 and said anode 34,
said separator 32 including cellulose nanofibers and cellulose microfibers and being porous and having a thickness between 5 μm and 20 μm and being wettable by aqueous and organic liquids,
each of said electrochemical cells 28 including said cathode 38 disposed above said first separator 32 disposed above said anode 34 with said cathode 38 and said separator 32 and said anode 34 and being stacked on top of one another in a sandwich configuration,
a casing 26 of electrically insulating material for protecting said electrochemical cell 28 from the environment,
said a casing 26 having a first end 22 and a second end 24 with said electrochemical cell there between
a first current collector 30 adjacent the first end 22 extending out of said casing 26 to form a protrusion 62,
a positive terminal 60 including said protrusion 62 and copper which overlays at least a portion of said protrusion 62,
a negative terminal 58 including an extension of a first anode 34 adjacent the second end 24 extending out of said casing 26, and
characterized by,
said anode being of aluminum of at least 99.95% by weight purity, and
each of said electrochemical cells 28 including an electrolyte including
a carboxymethylcellulose solution at 20 -40% by weight and including less than 10% by weight distilled water and causing said electrolyte to be lyophobic,
glycerol at 20-30% by weight
carbon nanotubes 5-10% by weight
hydroxyethyl cellulose at is 0.1%-0.5% by weight
sodium benzoate as an antiseptic at 0.1% by weight,
magnesium chloride at the saturation limit of said electrolyte.
